(19) United States
(12) Patent Application Publication
(10) Pub. No.: US 2020/0070832 A1
(43) Pub. Date: Mar. 5, 2020

(54) METHOD AND DEVICE FOR LOWERING THE TEMPERATURE OF AT LEAST ONE COMPONENT IN A VEHICLE

(71) Applicant: Robert Bosch GmbH, Stuttgart (DE)

(72) Inventor: Klaus Ries-Mueller, Bad Rappenau (DE)

(21) Appl. No.: 16/463,213

(22) PCT Filed: Oct. 4, 2017
(86) PCT No.: PCT/EP2017/075193

§ 371 Date: May 22, 2019

(30) Foreign Application Priority Data
Nov. 23, 2016 (DE) 10 2016 223 173.1

(51) Int. Cl. B60W 30/184; B60K 11/02

(52) U.S. Cl. CPC B60W 30/1843; B60W 20/15; B60K 11/02

(57) ABSTRACT

The invention relates to a method (100) for lowering the temperature of at least one component (410 . . . 470) in a vehicle (400), comprising the steps of: determining (110) future route-dependent data; lowering (130) the temperature of at least one component (410 . . . 470) as a function of the determined data.

### BACKGROUND OF THE INVENTION

The invention relates to a method and to a device for lowering the temperature of at least one component in a vehicle. The invention further relates to a drive train comprising a corresponding device and to a vehicle comprising a drive train and also to a computer program and to a machine-readable storage medium.

Road vehicles are increasingly being operated in an automated manner. DE 10 2007 053 279 A1 discloses, for example, a method for actuating the drive systems of a hybrid vehicle. The drive systems are actuated depending on data from surrounding area and environmental sensors, for example an air quality sensor, a video camera or a communications system, which each represent an aspect of the area immediately surrounding the vehicle. As automation of the operation of the vehicles increases and also with the increase in the efficiency of the vehicles, there is a further need to improve methods and devices of this kind.

### SUMMARY OF THE INVENTION

The invention provides a method for lowering the temperature of at least one component in a vehicle. The method comprises the steps of: determining future route-dependent data; and lowering the temperature of at least one component depending on the determined data.

The invention provides a method in which route-dependent data of a route which is to be driven in the future is determined. Said data is data which describes, represents and characterizes the future route of the vehicle or locations at which the vehicle stops. This data includes, in particular, surrounding area data or environmental data which is detected, in particular, by means of suitable sensors or is made available by means of a navigation device which is available in the vehicle. In particular, future route-dependent data can already be made available by means of a navigation device in advance if the route to be driven is already known, for example prespecified by the driver or a service provider, and the coordinates of the vehicle are combined with the data of the topological maps and further data which is relevant for operating the vehicle. The temperature of at least one component is lowered depending on this determined data. Therefore, a method for lowering the temperature of at least one component in a vehicle is provided. A large number of components which are heated to different extents during operation of the vehicle are installed in a vehicle. If individual components become too hot, for example a drive assembly becomes too hot, the power output thereof is reduced until the temperature has dropped to a permissible value again. In order to avoid the reduction in the power output of a component, in particular contrary to the driver request or the driving strategy, the temperature of the component is, according to the method, therefore already lowered in advance when corresponding data for the route to be driven in the future is present in such a way that traveling along the future route can take place without a reduction in the power on account of an excessively high temperature being established. A method for lowering the temperature of at least one component in a vehicle, which method allows efficient operation of the components in the vehicle, is advantageously provided. The requested vehicle acceleration during future acceleration events is therefore rendered possible. Furthermore, a future acceleration (boost mode) of the vehicle is prepared for by lowering the temperature, for example of the power electronics, battery or electrical machine in an electrically driven vehicle, depending on anticipatory navigation or surrounding area data in particular.

In a vehicle which is driven by an internal combustion engine, the internal combustion engine or a flange-connected turbocharger for example is analogously prepared for a future acceleration by means of lowering of the temperature. In particular, the components therefore also age to a lesser extent since, on average, smaller temperature differences and therefore smaller temperature loadings on the components occur.

In another refinement of the invention, lowering the temperature of at least one component comprises at least one of the following steps:

lowering the clock frequency of the actuation of a power electronics system of the vehicle;

changing the actuating method of a power electronics system of the vehicle;

increasing the coolant throughflow through the radiator or the cooling ducts of a component;

increasing the fan rotation speed for cooling a component;

increasing the cooling capacity of an air-conditioning system which serves to cool a component;

switching off an auxiliary assembly of a vehicle;

adjusting a transmission ratio of a transmission of the vehicle.

Lowering the temperature of at least one component comprises at least one of the following steps or takes place by applying at least one of the following steps:

for vehicles which comprise a power electronics system for example, in particular have an inverter for converting a DC voltage into an AC voltage for example for driving an electrical machine or have a DC-DC voltage converter, for example for converting a DC voltage of a high-voltage electrical system into a low voltage of a low-voltage electrical system or on-board electrical system, lowering the clock frequency of the actuation of the power electronics system can lead to reduced switching losses of the power semiconductor switches within the power electronics system. This results in a significant lowering of the temperature of the power electronics system. Changing the actuating method, for example the pulse-width modulation to a flat-top or block mode, also likewise preferably leads to a change in the thermal losses of the power electronics system and therefore also to influencing and lowering of the temperature of a power electronics system which is present in a vehicle. Components which are flange-connected to a radiator or themselves have integrated cooling ducts or similar elements for cooling the component are preferably operated at an increased coolant throughflow rate for lowering the temperature. Therefore, these components are cooled more rapidly to a lower temperature. In the case of air-cooled components, the fan rotation speed of a fan which is provided for them is preferably increased. Components which are cooled by means of an air-conditioning system which is preferably present in the vehicle are preferably cooled to a greater extent by means of increasing the cooling capacity of the air-conditioning system. Therefore, the temperature of said components is lowered. If a component serves, for example, to operate or to drive a plurality of assemblies or auxiliary assemblies, at least one auxiliary assembly is preferably switched off. As a result, the component is loaded to a lesser extent and therefore lowering of the temperature of the component is achieved. Furthermore, the transmission ratio of a transmission of the vehicle is preferably adjusted in such a way that the temperature of the component which is operatively connected to the transmission is lowered. For example, the thermal losses of a drive assembly are reduced as the rotation speed of the drive assembly, for example of an electrical machine or an internal combustion engine, is reduced. Different options which lead to lowering of a temperature of at least one component of the vehicle are advantageously provided.

In another refinement of the invention, the steps for lowering the temperature are selected or combined in such a way that reliable operation of the components of the vehicle while traveling along the future route is ensured and the energy required for lowering the temperature is minimized.

Said different measures for lowering the temperature of a component in a vehicle are selected according to existing components and the temperatures and limit temperatures thereof, as required, depending on the data which is dependent on future routes. The intensity of the measures which are then used is also selected depending on the respective temperature and limit temperatures of the components. The measures to be executed are selected and combined by means of weighting the individual measures, preferably depending on the energy required for said measures or the emissions associated with said measures. Therefore, lowering the temperature of a component takes place together with minimizing the energy additionally required for this purpose and the increased emissions which are associated with it. This applies both to lowering the temperature of an individual component and also in the case of the temperature of a large number of components of the vehicle being lowered. A selection strategy for selecting the respective measures to be used is advantageously provided.

In another refinement of the invention, determining future route-dependent data comprises at least one of the following steps:

determining the expected thermal losses of at least one component when traveling along future route sections;

determining the expected thermal losses of at least one component when traveling along a future slope depending on the steepness and length of the slope;

determining the expected thermal losses of at least one component for an imminent acceleration process;

determining the expected thermal losses of at least one component for the future stopping at a location;

determining the expected thermal losses of at least one component when traveling along future route sections depending on the driver request or the operating strategy of an automated vehicle.

Determining future route-dependent data preferably comprises at least one of the following steps:

The expected thermal losses of at least one component when traveling along future route sections are preferably determined.

The expected thermal losses of at least one component when traveling along a future route are preferably determined depending on the slope and length of said route. In particular, the expected thermal losses increase as the slope increases and the length of the route increases. The expected thermal losses of at least one component for an imminent acceleration process are preferably determined. For example, an imminent overtaking process or filtering into an expressway or motorway is identified as an acceleration process on the basis of data, for example on the basis of map data of a navigation system, in particular as part of at least partially autonomous driving, and by means of a corresponding surrounding area sensor system, for example communication of vehicles with one another. Higher thermal losses are expected as the acceleration increases. Thermal losses are also expected in the case of an interruption in driving, which is planned for example as part of a route plan, for example for future stopping at a location. For example, if a component, preferably a high-voltage battery, is intended to be charged by means of a rapid charging process or, for example, the climate of the vehicle is controlled when stationary. In this case in particular, but also in the case of the other described measures, the expected external temperature is included in the process of determining the expected thermal losses. Furthermore, the driver request or a learnt driving profile of a driver or an operating strategy of an automated vehicle, for example an autonomously driving vehicle, are taken into account when determining the expected thermal losses of at least one component when traveling along future route sections. Different options for determining future route-dependent data are advantageously provided.

In another refinement of the invention, the component is at least one sub-component of a power electronics system, of a voltage converter, of a battery, of an electrical machine, of an internal combustion engine, of a component of the internal combustion engine or of a component of the exhaust gas system of the internal combustion engine.

The component in a vehicle, the temperature of which component is intended to be lowered, can be, for example, a power electronics system or at least one sub-component of said power electronics system. Said sub-component could be, in particular, an inverter for converting a DC voltage into an AC voltage for driving an electrical machine, preferably also the circuit breakers and diodes contained therein. A component to be cooled is preferably also a voltage converter, in particular a DC-DC voltage converter, with circuit breakers and current-carrying components likewise contained therein. Said voltage converter serves, for example, to convert a high voltage into a low voltage in a vehicle. The component is preferably a battery, or an individual module of the battery, in particular a high-voltage or traction battery for electrically driving a vehicle. The component is preferably an electrical machine, or the rotor or stator of said electrical machine, for example for driving a vehicle. Furthermore, a component can be an internal combustion engine which serves to drive a vehicle or a sub-component of the internal combustion engine, for example a turbocharger of the internal combustion engine, preferably the drive of the turbocharger or the blades of said turbocharger as a sub-component. A component can preferably also be associated with the exhaust gas system of an internal combustion engine, which exhaust gas system serves to purify the exhaust gas of an internal combustion engine. A selection of a large number of possible components is advantageously provided, the temperature of said components being cooled in advance for operation, as intended, under full load.

The invention further relates to a computer program which is designed to execute one of the methods described above.

The invention further relates to a machine-readable storage medium on which the described computer program is stored.

The invention further relates to a device for lowering the temperature of at least one component in a vehicle, wherein the device is designed to determine data depending on future routes and to lower the temperature of at least one component depending on the determined data.

A device which allows operation of the components on future routes at full load, for example a maximum vehicle acceleration in the case of future acceleration events, is advantageously provided. A subsequent future acceleration is prepared for by lowering the temperature of a component depending on anticipatory navigation or surrounding area data.

The invention further relates to a drive train comprising a described device and, in particular, comprising a power electronics system, a battery, an electrical machine, an internal combustion engine and/or an exhaust gas system. A drive train of this kind serves, for example, to drive a vehicle. Efficient operation of the drive train is rendered possible by means of the method and the device.

The invention further relates to a vehicle comprising a described drive train. A vehicle which comprises a device for lowering the temperature of at least one component of the vehicle is advantageously provided.

It goes without saying that the features, properties and advantages of the method according to the invention accordingly relate and can be applied to the device and, respectively, to the drive train and the vehicle, and vice versa.

Further features and advantages of embodiments of the invention can be found in the following description with reference to the appended drawings.

### BRIEF DESCRIPTION OF THE DRAWINGS

The invention will be explained in more detail below with reference to some figures, in which:

FIG. 1 shows a schematic illustration of a vehicle comprising a drive train and a device for lowering the temperature of at least one component, and

FIG. 2 shows a schematically illustrated flowchart of a method for lowering the temperature of at least one component.

### DETAILED DESCRIPTION

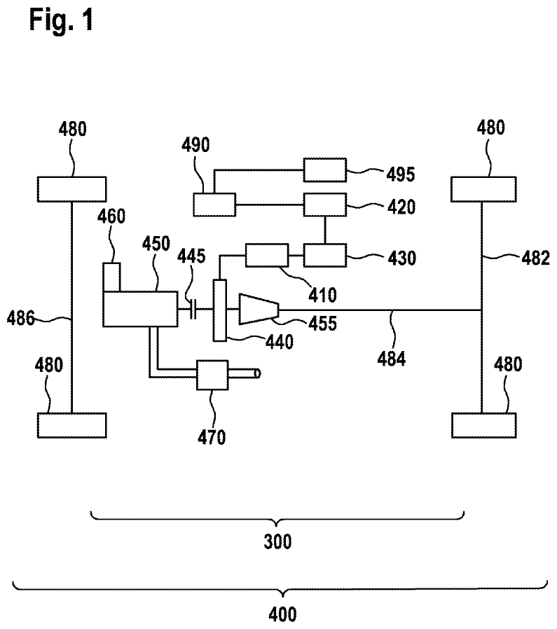

FIG. 1 shows a device 490 for lowering the temperature of at least one component 410 . . . 470, or a sub-component of said component, in a vehicle 400. The device 490 is designed to determine data depending on future routes. To this end, the device 490 is connected to sensor devices and data detection devices 495. Depending on the data, the device 490 actuates further devices of the vehicle which lead to lowering of the temperature of at least one of the components 410 . . . 470. The connection between the voltage converter 420 and the device 490 is schematically illustrated. The voltage converter 420 supplies a low voltage to the device 490 as operating voltage. To this end, the voltage converter 420 converts the voltage of the battery 430, preferably a high voltage of a high-voltage battery of 300 volts for example, into a low voltage, for example to 48 volts or 12 volts. The battery 430 is connected to the electrical machine 440 by means of a power electronics system 410, in particular an inverter. A further component, not illustrated in FIG. 1, in particular a step-up converter, is preferably provided between the battery 430 and the power electronics system 410 for converting, in particular for stepping up, the voltage of the battery 430 into the input voltage of the power electronics system 410, for example from 300 volts to 600 or 800 volts. The power electronics system 410 provides the electrical energy for supplying power to the electrical machine 440. To this end, the power electronics system 410 converts the input voltage of the power electronics system 410 into an AC voltage. The electrical machine can be connected to an internal combustion engine 450 by means of a coupling 445, preferably a clutch. A turbocharger 460 is flange-connected to the internal combustion engine 450, preferably for increasing the power. An exhaust gas system, which comprises a component 470 of the exhaust gas system, is provided for purifying the exhaust gas of the internal combustion engine 450. The two drive assemblies, the internal combustion engine 450 and the electrical machine 440, can be coupled to an output shaft 484, which drives wheels 480 by means of an axle 482, by means of a transmission 455, preferably a manual transmission or an automatic transmission. The drive train 300 comprises the device 490 and at least one of the described components 410 . . . 470. Here, the vehicle 400 is schematically illustrated with a further two wheels 480 on a further axle 486. However, the vehicle 400 may also be a one-, two- or multiple-wheel drive land vehicle, watercraft or aircraft.

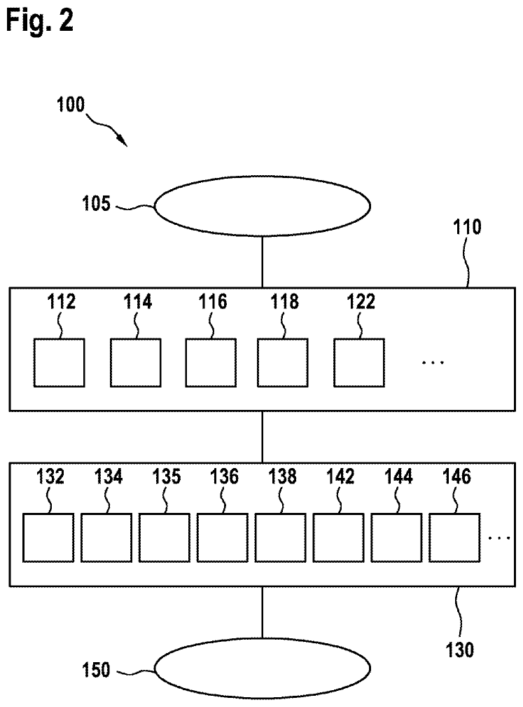

FIG. 2 shows a schematic sequence of the method 100 for lowering the temperature of at least one component 410 . . . 470 in a vehicle 400. The method starts with step 105. In step 110, future route-dependent data is determined. This can be done in various ways, so that, for example, in step 112, the expected thermal losses of at least one component 410 . . . 470 when traveling along future route sections are determined, in particular the expected thermal losses correlate to the power requirement which is required in the future or is expected to be required. In step 114, the expected thermal losses of at least one component 410 . . . 470 when traveling along a future route are preferably determined depending on the slope and length of said route. In step 116, the expected thermal losses for an imminent acceleration process are preferably determined. In step 118, the expected thermal losses for the future stopping at a location are preferably determined. In step 122, the expected thermal losses when traveling along future route sections are preferably determined depending on the driver request or the operating strategy of an automated vehicle. In addition to these method steps, further method steps are also possible, this being indicated by the sequence of dots within step 110. In step 130, the temperature of at least one component 410 . . . 470 is lowered depending on the determined data. To this end, a large number of steps is once again possible. By way of example, in step 132, the clock frequency of a power electronics system of the vehicle is lowered. In step 134, the actuation method of a power electronics system of the vehicle is preferably changed, for example a switchover is made from the sinusoidal pulse-width modulation to a block mode (square-wave actuation or flat-top mode). In step 135, the switching dynamics of the power electronics system are preferably changed, for example by means of changing a gate series resistance of a circuit breaker of the power electronics system. In this context, changing the switching dynamics is understood to mean, in particular, changing the period of time which is required by the circuit breaker in order to change over from the switched-on to a switched-off state, and vice versa. In step 136, the coolant throughflow through a radiator or through cooling ducts of a component is preferably increased. In step 138, the fan rotation speed of a fan for cooling a component is preferably increased. In step 142, the cooling capacity of an air-conditioning system, which serves to cool a component, is preferably increased. In step 144, an auxiliary assembly of the vehicle is preferably switched off and furthermore, in step 146, a transmission ratio of a transmission of the vehicle is preferably adjusted for lowering the temperature of at least one component 410 . . . 470. Further measures are also conceivable in step 130, this being illustrated in the drawing by the sequence of dots in step 130. The method ends with step 150.

1. A method (100) for lowering the temperature of at least one component (410 . . . 470) in a vehicle (400), the method comprising:
determining (110), via a computer, future route-dependent data;
lowering (130), via the computer, the temperature of at least one component (410 . . . 470) depending on the future route-dependent data.

2. The method as claimed in claim 1,
wherein lowering (130) the temperature of at least one component (410 . . . 470) comprises at least one of the following:
lowering (132) the clock frequency of the actuation of a power electronics system of the vehicle;
changing (134) the actuating method of a power electronics system of the vehicle;
changing the switching dynamics (135) of the power electronics system;
increasing the coolant throughflow (136) through the radiator or the cooling ducts of a component;
increasing the fan rotation speed (138) for cooling a component;
increasing the cooling capacity (142) of an air-conditioning system which serves to cool a component;
switching off (144) an auxiliary assembly of the vehicle;
adjusting (146) a transmission ratio of a transmission of the vehicle.

3. The method as claimed in claim 2,
wherein the steps (132 . . . 144) for lowering the temperature are selected or combined in such a way that reliable operation of the components (410 . . . 470) of the vehicle (400) when traveling along the future route is ensured and the energy required for lowering (130) the temperature is minimized.

4. The method as claimed in claim 1,
wherein determining (110) future route-dependent data comprises at least one of the following:
determining the expected thermal losses of at least one component (410 . . . 470) when traveling along future route sections (112);
determining the expected thermal losses of at least one component (410 . . . 470) when traveling along a future route depending on the slope and length of said route (114);
determining the expected thermal losses of at least one component (410 . . . 470) for an imminent acceleration process (116);
determining the expected thermal losses of at least one component (410 . . . 470) for the future stopping at a location (118);
determining the expected thermal losses of at least one component (410 . . . 470) when traveling along future route sections depending on the driver request or the operating strategy of an automated vehicle (122).

5. The method as claimed in claim 1,
wherein the component (410 . . . 470) is at least one sub-component of a power electronics system (410), of a voltage converter (420), of a battery (430), of an electrical machine (440), of an internal combustion engine (450) or of a component of the internal combustion engine (460) or of a component of the exhaust gas system (470) of the internal combustion engine.

6. (canceled)

7. A non-transitory machine-readable storage medium containing computer-executable instructions that when executed by a computer cause the computer to
determine (110) future route-dependent data;
lower (130) the temperature of at least one component (410 . . . 470) depending on the future route-dependent data.

8. (canceled)

9. A drive train (300) comprising a computer (490) configured to
determine data depending on future routes; and
lower the temperature of at least one component depending on the determined data.

10. (canceled)
